(19) United States
(12) Patent Application Publication
(10) Pub. No.: US 2017/0278093 A1
(43) Pub. Date: Sep. 28, 2017

(54) Mobile Device Based System for Redeeming Reward Points and Method of Operating the Mobile Device Based System

(71) Applicant: Michael J. Emoff, Dayton, OH (US)

(72) Inventor: Michael J. Emoff, Dayton, OH (US)

(21) Appl. No.: 15/079,015

(22) Filed: Mar. 23, 2016

(51) Int. Cl. G06Q 20/34; G06Q 20/32

(52) U.S. Cl. CPC G06Q 20/342; G06Q 20/3224

(57) ABSTRACT

A method of operating a mobile device based system is provided to facilitate a user to redeem reward points of a reward program. The method comprises monitoring location of a mobile device associated with the user. The method further comprises electronically by a processor, determining if a reward account associated with the mobile device contains available reward points for redemption by the user. The method also comprises presenting a redemption notification to the mobile device when location of the mobile device moves within a geofence boundary of a partner of the reward program and a determination has been made that the reward account contains available reward points for redemption by the user, wherein the redemption notification contains a redemption offer for a gift card by the partner of the reward program to the user.

### FIELD

The present disclosure relates to recognition and reward systems, and is particularly directed to a mobile device based system for redeeming reward points and method of operating the mobile device based system.

### BACKGROUND

Recognition and reward systems are used by supervisors, co-workers, or customers to reward points for beneficial behavior exhibited by employees. The reward points accumulated by employees may be “cashed in” for lifestyle awards or products, such as gift cards, that have been made available to the employee by the company or a rewards management company that has contracted with the company. Therefore, recognition and reward systems provide employees with an incentive to perform their duties in accordance with company directives.

A drawback of known recognition and reward systems is that employees often lose interest not only in earning reward points but also redeeming reward points after initial enrollment in a reward program to earn reward points. This loss of interest can be attributed to a number of different reasons including employees just simply forgetting about their enrollment in the reward program. It would be desirable to overcome drawbacks of known recognition and reward systems.

### SUMMARY

In one aspect, a method of operating a mobile device based system is provided to facilitate a user to redeem reward points of a reward program. The method comprises monitoring location of a mobile device associated with the user. The method further comprises electronically by a processor, determining if a reward account associated with the mobile device contains available reward points for redemption by the user. The method also comprises presenting a redemption notification to the mobile device when location of the mobile device moves within a geofence boundary of a partner of the reward program and a determination has been made that the reward account contains available reward points for redemption by the user, wherein the redemption notification contains a redemption offer for a gift card by the partner of the reward program to the user.

In another aspect, a method of operating a mobile device based system is provided to facilitate a user to redeem reward points of a reward program. The method comprises receiving, by a mobile device associated with the user, a redemption notification including a redemption offer for a gift card from a partner of the reward program when location of the mobile device moves within a geofence boundary of the partner.

In yet another aspect, a mobile device based system is provided for facilitating a user to redeem reward points of a reward program. The mobile device based system comprises a first processor configured for monitoring location of a mobile device associated with the user. The mobile device based system further comprises a second processor configured for determining if a reward account associated with the mobile device contains available reward points for redemption by the user. The mobile device based system also comprises a third processor configured for presenting a redemption notification to the mobile device when location of the mobile device associated with the user moves within a geofence of a partner of the reward program and a determination has been made that the reward account associated with the user contains an available number of reward points for redemption by the user, wherein the redemption notification contains a redemption offer for a gift card by the partner of the reward program to the user.

Other aspects will become apparent from the following detailed description, the accompanying drawings and the appended claims.

### BRIEF DESCRIPTION OF THE DRAWINGS

FIG. 1 is a block diagram of a mobile device based system for facilitating a mobile user to redeem reward points in accordance with an embodiment.

FIG. 2 is a flow diagram of a method of operating the mobile based system of FIG. 1 in accordance with an embodiment.

FIGS. 3A and 3B are redemption notification screens in accordance with various embodiments.

FIG. 4 is a redemption options screen in accordance with an embodiment.

FIGS. 5A and 5B are redemption receipt screens in accordance with various embodiments.

FIG. 6 is a flow diagram of a method of operating the mobile based system of FIG. 1 in accordance with another embodiment.

### DETAILED DESCRIPTION

The present disclosure is directed to a mobile device based system for redeeming reward points and a method of operating the mobile device based system. The specific and construction of the mobile device based system for redeeming reward points and the industry in which the system is implemented may vary. It is to be understood that the disclosure below provides a number of embodiments or examples for implementing different features of various embodiments. Specific examples of components and arrangements are described to simplify the present disclosure. These are merely examples and are not intended to be limiting.

By way of example, the disclosure below describes a mobile device based system for redeeming reward points of a recognition and reward system implemented by an employer for employees of a company. An example recognition and reward system implemented for employees of a company is disclosed in U.S. Pat. No. 8,608,062 issued on Dec. 17, 2013, the disclosure being fully incorporated by reference herein.

Although the description herein describes mobile device based systems and methods for facilitating employees of a company to redeem reward points, it is conceivable that mobile device based systems and methods may be implemented to facilitate other types of users to redeem reward points. For example, another type of mobile device user may comprise consumers of goods and services. For instance, the recognition and reward system can be implemented by a retailer, such as a chain-grocery store, for consumers to redeem points for gasoline at a gasoline station. As another example, another type of mobile device user may comprise a contractee performing services for a contractor. Other types of mobile device users are possible.

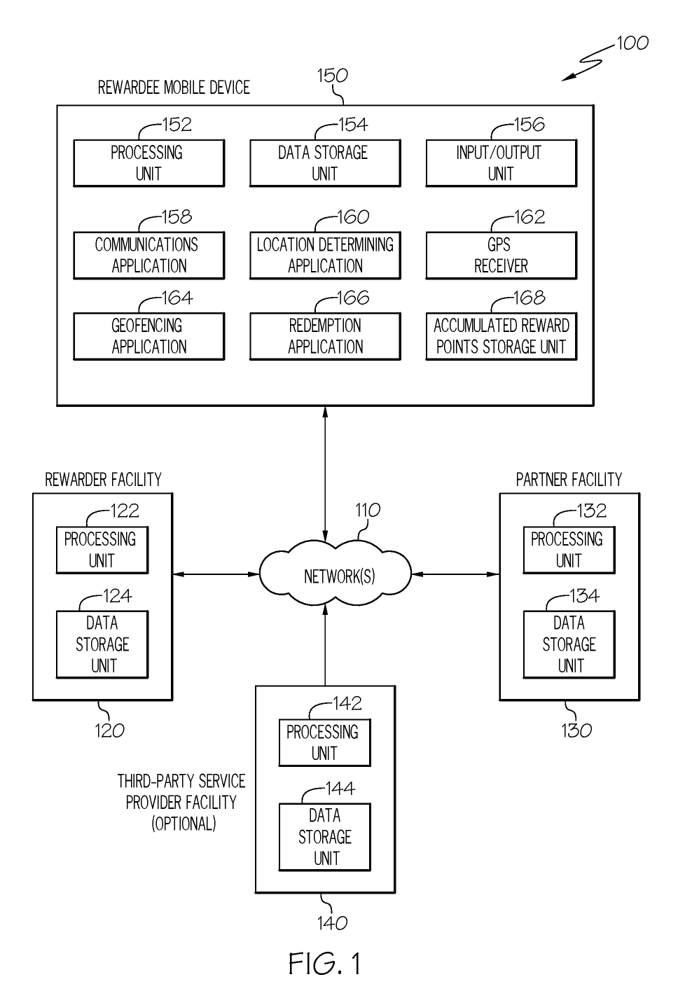

Referring to FIG. 1, a block diagram of mobile device based reward points redemption system 100 is illustrated. Redemption system 100 comprises one or more communications networks 110 that interconnect rewarder facility 120, partner facility 130, optional third-party service provider 140, and rewardee mobile device 150.

Rewarder facility 120 (i.e., the rewarder) is associated with an entity that rewards points in a reward program. For example, rewarder 120 may comprise an employer. As another example, rewarder 120 may comprise a retailer. As yet another example, rewarder 120 may comprise a service provider. Other types of rewarders are possible.

Partner facility 130 (i.e., the partner) is associated with an entity that is affiliated with rewarder 120 to provide goods or services when reward points in the reward program are redeemed. For example, partner 130 may comprise a retail merchant such as a department store. As other examples, partner 130 may comprise a restaurant, an airline, or a gasoline station. Other types of partners are possible.

Optional third-party service provider 140 is typically affiliated with either rewarder 120 or partner 130, or both, to provide service support thereto. For example, third-party service provider 140 may comprise a rewards management company.

Rewardee mobile device 150 is associated with a user (i.e., the rewardee) that desires to earn and accumulate reward points from rewarder 120, and then redeem the accumulated reward points for goods or services from partner 130. As mentioned, mobile device user may comprise an employee of a company.

Each of the one or more communications networks 110 may comprise any type of technology. The one or more communications networks 110 may comprise the Internet, a cellular phone network, a wide area network (WAN), a local area network (LAN), or any combination thereof. Other types of communications networks and communications network technologies are possible.

Rewarder facility 120 includes processing unit 122 that executes instructions stored in data storage unit 124. Processing unit 122 may comprise any type of technology. For example, processing unit 122 may comprise a general-purpose server. Other types of servers and processing unit technologies are possible. Data storage unit 124 may comprise any type of technology. For examples, data storage unit 124 may comprise random access memory (RAM), read only memory (ROM), solid state memory, or any combination thereof. Other types of memories and data storage unit technologies are possible.

Partner facility 130 includes processing unit 132 that executes instructions stored in data storage unit 134. Processing unit 132 may comprise any type of technology. For example, processing unit 132 may comprise a general-purpose server. Other types of servers and processing unit technologies are possible. Data storage unit 134 may comprise any type of technology. For examples, data storage unit 134 may comprise random access memory (RAM), read only memory (ROM), solid state memory, or any combination thereof. Other types of memories and data storage unit technologies are possible.

Optional third-party server provider facility 140 includes processing unit 142 that executes instructions stored in data storage unit 144. Processing unit 142 may comprise any type of technology. For example, processing unit 142 may comprise a general-purpose server. Other types of servers and processing unit technologies are possible. Data storage unit 144 may comprise any type of technology. For examples, data storage unit 144 may comprise random access memory (RAM), read only memory (ROM), solid state memory, or any combination thereof. Other types of memories and data storage unit technologies are possible.

Rewardee mobile device 150 on which a reward points redemption application in accordance with an embodiment can reside is shown. Mobile device 150 may comprise any type of technology. For examples, mobile device 150 may comprise a smart phone, a tablet computer, or a laptop computer. Other types of mobile devices and mobile device technologies are possible.

Mobile device 150 includes processing unit 152 that executes instructions stored in internal data storage unit 154, external data storage unit (not shown), or a combination thereof. Processing unit 152 may comprise any type of technology. For example, processing unit 152 may comprise a general-purpose electronic processor. Other types of processors and processing unit technologies are possible. Internal data storage unit 154 may comprise any type of technology. For examples, internal data storage unit 154 may comprise random access memory (RAM), read only memory (ROM), solid state memory, or any combination thereof. Other types of memories and data storage unit technologies are possible.

Mobile device further includes a number of input/output (I/O) devices 156 that may comprise any type of technology. For example, I/O devices 156 may comprise a keypad, a keyboard, a touch-sensitive display screen, a liquid crystal display (LCD) screen, a microphone, a speaker, or any combination thereof. Other types of I/O devices and technologies are possible.

Mobile device 150 also includes communications application 158 that communicates via one or more communications networks 110 with servers to access information contained on the servers. For example, communications application 158 may comprise a web browser application that accesses web pages of web servers via one or more communications networks 110. Web browsers are known and, therefore, will not be described.

Mobile device 150 also includes location determining application 160 that communicates via one or more communications networks 110 with suitable location service provider to determine location (e.g., latitude and longitudinal coordinates) of mobile device 150. Location determining applications are known and, therefore, will not be described. Alternatively or additionally, mobile device 150 includes a position receiver 162 that may comprise any type of technology. For example, position receiver may comprise a Global Positioning System (GPS) receiver that receives signals from a number of orbiting GPS satellites.

Mobile device 150 further includes geofencing application 164 that runs to define a boundary (i.e., a geofence boundary) around each one of at least one physical location associated with partner 130. For example, the at least one physical location may comprise location of a retail store associated with partner 130. Other types of physical locations are possible. The shape of the geofence boundary may be circular to define a circular region. Other geofence boundary shapes are possible. Geofencing applications are known and, therefore, will not be further described.

Mobile device 150 further includes reward points redemption application 166 that enables the user of mobile device 150 to redeem reward points from a reward program. Redemption application 166 can be downloaded onto mobile device 150 from rewarder 120, partner 130, or optional third-party service provider 140, or any combination thereof, for examples.

Mobile device 150 also includes accumulated reward points storage unit 168 that stores reward points accumulated in the user's reward account. It is conceivable that reward points accumulated in the user's reward account may be stored, either alternatively or additionally, at other locations. For examples, accumulated reward points can be stored in data storage unit 154 of mobile device 150, data storage unit 124 of rewarder 120, data storage unit 134 of partner 130, data storage unit 144 of third-party service provider 140, or any combination thereof.

Processing unit 152 of mobile device 150 executes redemption application 166, geofencing application 164, location determining application 160, or any combination thereof, to enable user of mobile device 150 to redeem reward points from the user's reward account, as will be described hereinbelow. It is conceivable that other processing units can be used to execute redemption application 166, geofencing application 164, and location determining application 160. For examples, processing unit 122 of rewarder 120, processing unit 132 of partner 130, processing unit 142 of third-party service provider 140, or any combination thereof, can be used, either alternatively or additionally to processing unit 152 of mobile device 150, to execute redemption application 166, geofencing application 164, location determining application 160, or any combination thereof.

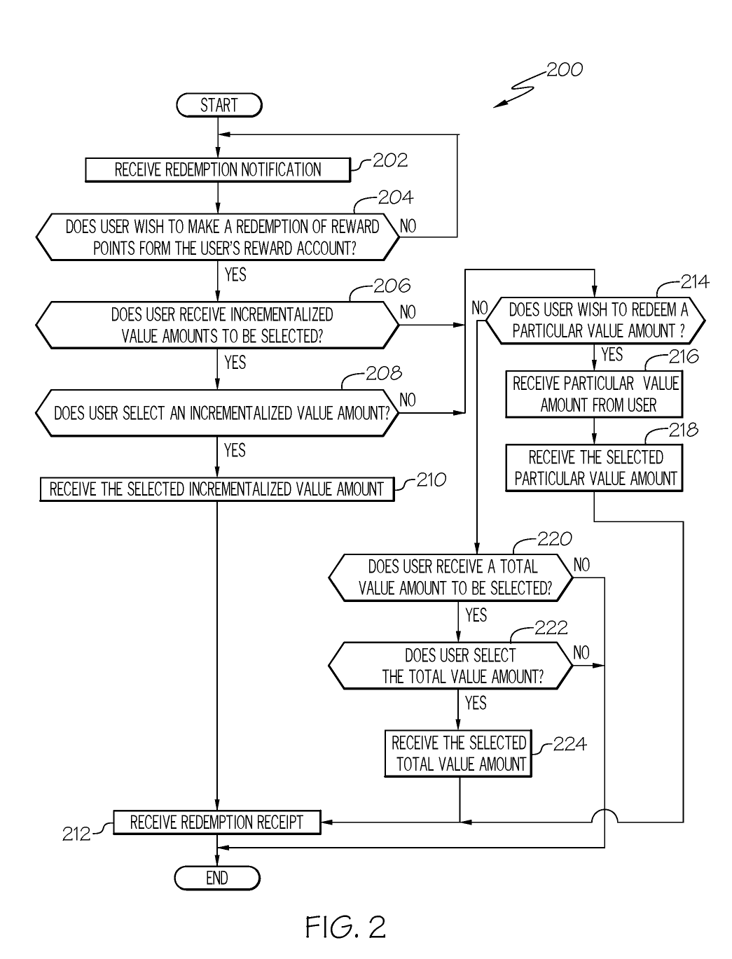

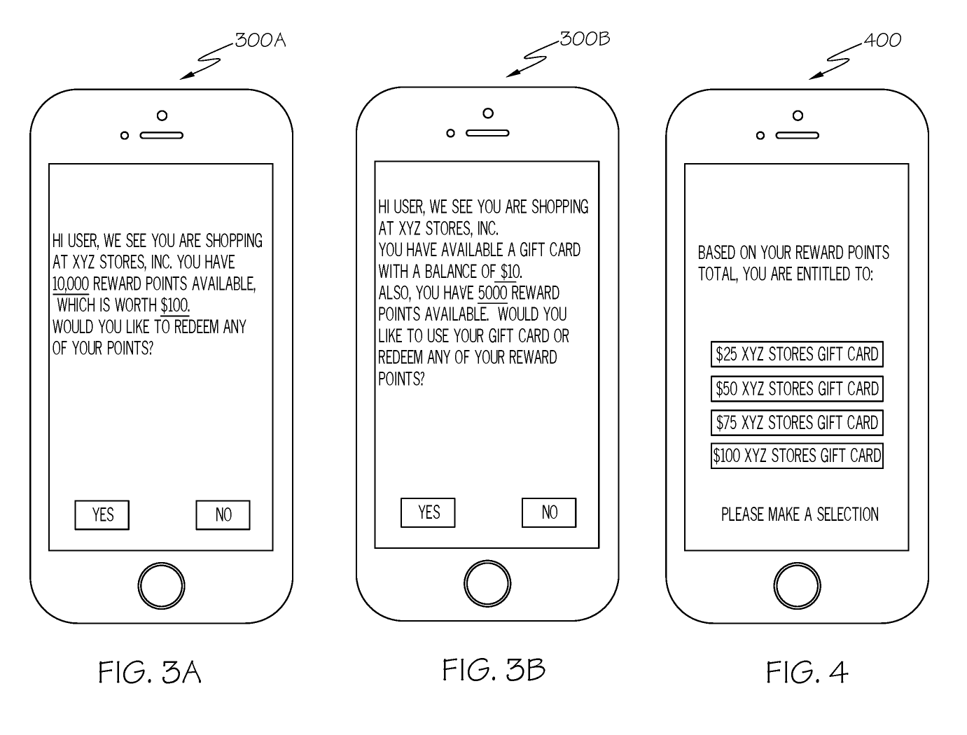

Referring to FIG. 2, flow diagram 200 of a method of operating the mobile based system 100 of FIG. 1 in accordance with an embodiment is illustrated. In block 202, the user of mobile device 150 receives a redemption notification offer for a gift card from partner 130 on I/O unit 156 of mobile device 150. The gift card may comprise an electronic gift card, a physical gift card, or a combination thereof. An example redemption notification screen 300A is shown in FIG. 3A as being on a display of mobile device 150. Another example redemption notification screen 300B is shown in FIG. 3B as being on a display screen of mobile device 150. A determination is made in block 204 as to whether the user of mobile device 150 wishes to make a redemption of reward points from the user's reward account. If the determination in block 204 is negative (i.e., the user does not wish to redeem reward points from the reward account), then the process returns back to block 202. However, if the determination in block 204 is affirmative (i.e., the user does wish to redeem reward points from the reward account), then the process proceeds to block 206.

In block 206, a determination as to whether the user of mobile device 150 receives an indication of incrementalized value amounts that can be selected. An example indication of incrementalized value amounts in the form of redemption options screen 400 that can be selected is shown in FIG. 4 as being on a display of mobile device 150. Although the incrementalized value amounts are shown in FIG. 4 as discrete amounts (i.e., $25, $50, $75, and $100), the incrementalized value amounts can be non-discrete. As an example, a non-discrete amount can be $42.33 which may be based on 4233 reward points. This enables the user to redeem only the number of reward points needed to pay the exact amount of a bill, such as a food bill at a restaurant, for example. If the determination in block 206 is affirmative (i.e., the user receives an indication of incrementalized value amounts that can be selected), then the process proceeds to block 208.

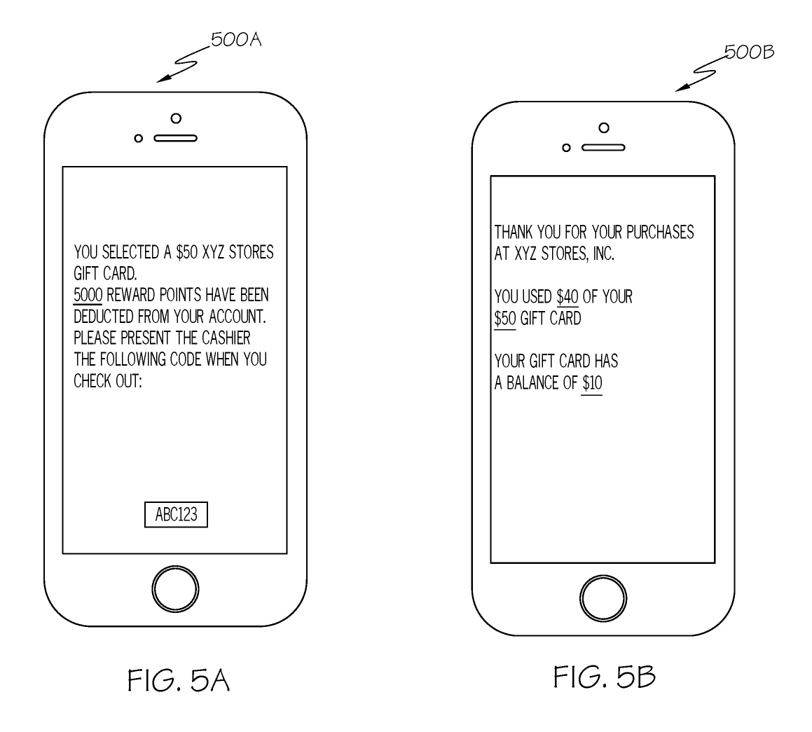

A determination is made in block 208 as to whether the user of mobile device 150 selects one of the indication of incrementalized value amounts that are displayed on mobile device 150. If the determination in block 208 is affirmative (i.e., the user selects one of the indication of incrementalized value amounts), then the process proceeds to block 210 in which the user receives the selected incrementalized value amount that can be indicated on a receipt for example. More specifically, as shown in block 212, the user of mobile device 150 can receive example redemption receipt screen 500A as shown in FIG. 5A. Another example redemption receipt screen 500B is shown in FIG. 5B as being on a display of mobile device 150. Example redemption receipt screen 500B may be presented immediately after the user has redeemed some or all reward points, or at a later time after reward points have been redeemed. The process then ends.

However, if the determination back in either block 206 or block 208 is negative (i.e., the user either does not receive any incrementalized redemption options to be selected or the user does not select an indicated incrementalized value amount), then the process proceeds to block 214. In block 214, a determination is made as to whether the user wishes to redeem reward points for a particular value amount. If the determination in block 214 is affirmative (i.e., the user wishes to redeem reward points for a particular value amount), then the process proceeds to block 216. After the particular value amount is provided via I/O unit 156 (FIG. 1) by the user in block 216, the process proceeds to block 218. In block 218, the user receives the particular value amount. The process then proceeds to block 212 in which the user receives a redemption receipt indicating the selected particular value amount delivered to the user. The process then ends.

However, if the determination back in block 214 is negative (i.e., the user does not wish to redeem reward points for a particular value amount), then the process proceeds to block 220. A determination is made in block 220 as to whether the user of mobile device 150 receives an indication of a total value amount that can be selected to be redeemed. If the determination in block 220 is negative (i.e., the user does not receive a total value amount that can be selected to be redeemed), then the process ends. However, if the determination in block 220 is affirmative (i.e., the user does receive a total value amount that can be selected to be redeemed), then the process proceeds to block 222.

A determination is made in block 222 as to whether the user of mobile device 150 selects the total value amount to redeem it. If the determination in block 222 is negative (i.e., the user does not select the total value amount to redeem it), then the process ends. However, if the determination in block 222 is affirmative (i.e., the user does select the total value amount to redeem it), then the process proceeds to block 224. In block 224, the user of mobile device 150 receives the selected total value amount. The total value amount received can be indicated on a receipt for example. As an example, as shown in block 212, the user of mobile device 150 can receive example redemption receipt screen 500A as shown in FIG. 5A.

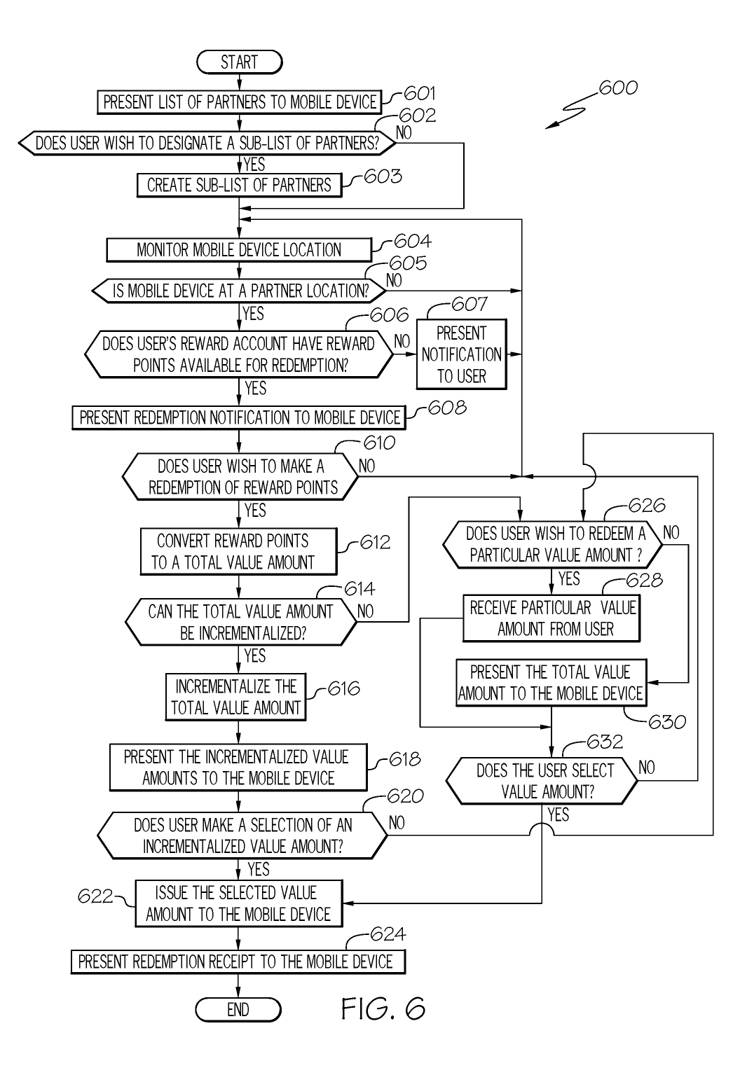

Referring to FIG. 6, flow diagram 600 of a method of operating the mobile based system 100 of FIG. 1 in accordance with another embodiment is illustrated. In block 601, a list of partners associated with the rewards program is presented on a display of mobile device 150 to allow the user to create a sub-list of partners. Alternatively, the process of filtering to create a sub-list of partners may be performed on a device other than the mobile device 150, such as on a personal computer. A determination is made in block 602 as to whether the user wishes to designate a sub-list of partners from the list of partners. If the determination in block 602 is affirmative (i.e., the user wishes to create a sub-list of partners), then the process proceeds to block 603 to create the sub-list of partners before proceeding to block 604. However, if the determination in block 602 is negative (i.e., the user does not wish to create a sub-list of partners), then the process proceeds directly to block 604.

The user of mobile device 150 can create a sub-list any time after redemption application (FIG. 1) has been downloaded to mobile device 150. The user has filtered the list of partners to provide the sub-list of partners that the user has particular interest in. For example, the user can create a sub-list of partners by selecting partners who only sell gasoline or automotive products. As another example, the user can create a sub-list of partners by selecting partners who only sell men's shoes and clothing. The sub-lists can be as general or as specific as definable by the user. Other kinds of sub-lists, whether general or specific, are possible.

In one alternative implementation, the disclosed method 600 of operating the mobile based system 100 of FIG. 1 may facilitate the creation of a sub-list of partners by querying whether the user about particular partners. For example, once the user's mobile device 150 is detected at a location of partner 130 (i.e., the user's mobile device 150 moves within the geofence boundary of partner 130), as shown in block 605, the user may be queried: “Would you like to receive notifications about [partner]? Yes or No?” If the user selects “yes,” then that particular partner will be added to the sub-list. If the user selects “no,” then that particular partner will be omitted from the sub-list.

In block 604, the location of the user's mobile device 150 is monitored. A determination is made in block 605 as to whether the user's mobile device 150 is detected at a location of partner 130 (i.e., the user's mobile device 150 moves within the geofence boundary of partner 130). If the determination in block 605 is negative (i.e., the user's mobile device 150 is not within the geofence boundary), then the process returns back to block 604. However, if the determination in block 605 is affirmative (i.e., the user's mobile device 150 is within the geofence boundary), then the process proceeds to block 606.

A determination is made in block 606 as to whether the user's reward account of the reward program contains reward points available for redemption. If the determination in block 606 is negative (i.e., the user's reward account does not contain reward points available for redemption), then the process proceeds to block 607. In block 607, a notification such as “Do you want to learn how to earn more points?” can be presented on a display of mobile device 150 to provide the user with the opportunity to learn how to earn more reward points. The process then returns back to block 604 to continue monitoring location of the user's mobile device 150.

However, if the determination in block 606 is affirmative (i.e., the user's reward account does contain reward points available for redemption), then the process proceeds to block 608. In block 608, the user of mobile device 150 receives a redemption notification offer for a gift card on I/O unit 156 of mobile device 150. Example redemption notification screen 300A as shown in FIG. 3A or example redemption notification screen 300B can be presented on a display of mobile device 150. The process proceeds to block 610.

A determination is made in block 610 as to whether the user of mobile device 150 wishes to make a redemption of reward points from the user's reward account. If the determination in block 610 is negative (i.e., the user does not wish to redeem reward points from the reward account), then the process returns back to block 604. However, if the determination in block 610 is affirmative (i.e., the user does wish to redeem reward points from the reward account), then the process proceeds to block 612. In block 612, reward points from the user's reward account are converted to a total value amount that is associated with partner 130. The process proceeds to block 614.

A determination is made in block 614 as to whether the total value amount from block 612 that is associated with partner 130 can be incrementalized. If the determination in block 614 is affirmative (i.e., the total value amount from block 612 can be incrementalized), then the process proceeds to block 616 to incrementalize the total value amount. Then, in block 618, the incrementalized amounts from block 616 are presented on I/O unit 156 of user's mobile device 150 to allow the user to select an incrementalized value amount. An example indication of incrementalized value amounts in the form of redemption options screen 400 that can be selected is shown in FIG. 4 as being on a display of mobile device 150. The process then proceeds to block 620.

A determination is made in block 620 as to whether the user of mobile device 150 selects one of the indication of incrementalized value amounts that are displayed on mobile device 150. If the determination in block 620 is affirmative (i.e., the user selects one of the indication of incrementalized value amounts), then the process proceeds to block 622 in which the selected incrementalized value amount is issued to the user's mobile device 150. The issued incrementalized value amount can be indicated on a receipt for example. For example, as shown in block 624, the user's mobile device 150 can receive example redemption receipt screen 500A as shown in FIG. 5A. Another example redemption receipt screen 500B is shown in FIG. 5B as being on a display of mobile device 150. Example redemption receipt screen 500B may be presented immediately after the user has redeemed some or all reward points, or at a later time after reward points have been redeemed. The process then ends.

However, if the determination back in block 614 or block 620 is negative (i.e., the total value amount from block 612 cannot be incrementalized or the user does not make a selection of an incrementalized value amount), then the process proceeds to block 626. In block 626, a determination is made as to whether the user wishes to redeem reward points for a particular value amount. If the determination in block 626 is affirmative (i.e., the user wishes to redeem reward points for a particular value amount), then the process proceeds to block 628. After the particular value amount is provided via I/O unit 156 (FIG. 1) by the user in block 628, the process proceeds to block 632.

In block 632, a determination is made as to whether the user selects the particular value amount. If the determination in block 632 is affirmative (i.e., the user selects the particular value amount), then the process proceeds to block 622 to issue the selected particular value amount to the user's mobile device 150. The process then proceeds to block 624 in which the user receives a redemption receipt indicating the selected particular value amount delivered to the user. The process then ends. However, if the determination in block 632 is negative (i.e., the user does not select the particular value amount), then the process returns back to block 604 to continue monitoring location of user's mobile device 150.

However, if the determination in block 626 is negative (i.e., the user does not wish to redeem reward points for a particular value amount), then the process proceeds to block 630. In block 630, the total value amount from block 612 is presented to I/O unit 156 of mobile device 150 to allow the user to select the total value amount to redeem the total value amount. The process then proceeds to block 632.

A determination is made in block 632 as to whether the user of mobile device 150 selects the total value amount presented in block 630 to redeem the total value amount. If the determination in block 632 is negative (i.e., the user does not select the total value amount to redeem the total value amount), then the process returns back to block 604 to continue monitoring location of user's mobile device 150. However, if the determination in block 632 is affirmative (i.e., the user does select the total value amount to redeem the total value amount), then the process proceeds to block 622. In block 622, the selected total value amount is issued to the user's mobile device 150. The process then proceeds to block 624 in which the user receives a redemption receipt indicating the selected total value amount delivered to the user. The process then ends.

It should be apparent that the above-described mobile device based system 100 provides a new tool and methods to enable a mobile device user to not only conveniently earn and accumulate reward points of a reward points program, but to also conveniently redeem accumulated reward points for goods and services. Moreover, the new tool and methods enable rewarders, partners of the rewarders, and optional third-party service providers to exchange rewards data and program information while enabling rewardees to easily and conveniently earn, accumulate, and redeem reward points. Accordingly, the improved reward points redemption systems and methods address and resolve drawbacks in known reward points redemption systems and methods by keeping such programs from becoming irrelevant in the minds of users.

Aspects of disclosed embodiments may be implemented in software, hardware, firmware, or a combination thereof. The various elements of the system, either individually or in combination, may be implemented as a computer program product tangibly embodied in a machine-readable storage device for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

Although various aspects of disclosed embodiments have been shown and described, modifications may occur to those skilled in the art upon reading the specification. The present application includes such modifications and is limited only by the scope of the claims.

1. A method of operating a mobile device based system to facilitate a user to redeem reward points of a reward program, the method comprising:
connecting, electronically by a redemption application executed by a processor, a reward account associated with the user and the mobile device associated with the user;
monitoring, electronically by a location determination application executed by a processor, a location of the mobile device;
determining, electronically by the redemption application executed by the processor, if the reward account contains available accumulated reward points sufficient for redemption by the user for a redemption value provided by a partner of the reward program; and
presenting, electronically by the redemption application executed by the processor to the mobile device, a redemption notification containing a redemption offer to exchange at least a portion of the available accumulated reward points for a redemption value when location of the mobile device moves within a geofence boundary of the partner of the reward program and a determination has been made that the reward account contains available accumulated reward points sufficient for redemption by the user for the redemption value provided by the partner of the reward program, and wherein:
the user is an employee of an employer, and
reward points are electronically awarded to the employee by the employer in response to a recognizable action performed by the employee and accumulated in the reward account.

2. The method according to claim 1, further comprising:
presenting, electronically by the redemption application executed by the processor, one or more redemption value amount options to the mobile device, for selection by the user, after the user accepts the redemption offer.

3. The method according to claim 2, further comprising:
converting, electronically by the redemption application executed by the processor, at least a portion of the accumulated reward points to a total redemption value amount, corresponding to a selected one of the one or more redemption value amount options, that the user can redeem with the partner of the reward program.

4. The method according to claim 3, further comprising:
presenting, electronically by the redemption application executed by the processor, a redemption receipt, indicating the total redemption value amount, to the mobile device after the user has selected one of the one or more redemption value amount options presented to the mobile device.

5. The method according to claim 2, wherein presenting one or more redemption value amount options to the mobile device includes presenting at least two redemption value amount options to the mobile device.

6. The method according to claim 5, further comprising:
converting, electronically by the redemption application executed by the processor, at least a portion of the accumulated reward points to a total redemption value amount; and
presenting, electronically by the redemption application executed by the processor, the total redemption value amount as incrementalized value amounts to provide the at least two redemption value amount options to be presented to the mobile device that the user can redeem with the partner of the reward program.

7. The method according to claim 1, further comprising:
presenting, electronically by the redemption application executed by the processor, a list of partners of the reward program, for selection by the user, to allow the user to filter the list of partners of the reward program to create a sub-list of partners of the reward program.

8. The method according to claim 1, wherein the method is performed by a computer having a memory executing one or more programs of instructions which are tangibly embodied in a program storage medium readable by the computer.

9. A method of operating a mobile device based system to facilitate a user to redeem reward points of a reward program, the method comprising:
electronically connecting a reward account associated with the user and the mobile device associated with the user; and
receiving, by the mobile device, a redemption notification including a redemption offer to exchange at least a portion of reward points accumulated in the reward account for a gift card from a partner of the reward program when a location of the mobile device moves within a geofence boundary of the partner of the reward program and a determination has been made that the reward account contains available accumulated reward points sufficient for redemption by the user for the gift card from the partner of the reward program, and wherein:
the user is an employee of an employer, and
the reward points are electronically awarded to the employee by the employer in response to a recognizable action performed by the employee and transferred to the reward account.

10. The method according to claim 9, further comprising:
receiving, by the mobile device, one or more redemption value amount options after the user accepts the redemption offer for the gift card.

11. The method according to claim 10, further comprising:
receiving, by the mobile device, a redemption receipt, indicating a redemption value amount, after the user selects one of the one or more redemption value amount options.

12. The method according to claim 10, wherein receiving, by the mobile device, one or more redemption value amount options after the user accepts the redemption offer for the gift card includes:
receiving, by the mobile device, at least two redemption value amount options after the user accepts the redemption offer for the gift card.

13. The method according to claim 12, further comprising:
receiving, by the mobile device, a redemption receipt, indicating a redemption value amount, after the user selects one of the at least two redemption value amount options.

14. The method according to claim 9, wherein the method is performed by a computer having a memory executing one or more programs of instructions which are tangibly embodied in a program storage medium readable by the computer.

15. A mobile device based system for facilitating a user to redeem reward points of a reward program, the mobile device based system comprising:
at least one processing unit; and
a non-transitory computer-readable storage medium comprising computer-executable instructions that, when executed by the at least one processing unit, causes the at least one processing unit to:
connect a reward account associated with the user and the mobile device associated with the user;
monitor a location of the mobile device;
determine if the reward account contains available accumulated reward points sufficient for redemption by the user for a redemption value provided by a partner of the reward program; and
present a redemption notification containing a redemption offer to exchange at least a portion of the available accumulated reward points for the redemption value to the mobile device when location of the mobile device moves within a geofence boundary of the partner of the reward program and a determination has been made that the reward account contains available accumulated reward points sufficient for redemption by the user for the redemption value provided by the partner of the reward program, and wherein:
the user is an employee of an employer,
reward points are electronically awarded to the employee by the employer in response to a recognizable action performed by the employee and accumulated in the reward account.

16. The mobile device based system according to claim 15, wherein the computer-executable instructions further causes the at least one processing unit to present one or more redemption value amount options to the mobile device, for selection by the user, after the user accepts the redemption offer for the gift card.

17. The mobile device based system according to claim 16, wherein the computer-executable instructions further causes the at least one processing unit to present a redemption receipt, indicating a redemption value amount, to the mobile device after the user has selected one of the one or more redemption value amount options presented to the mobile device.

18. The mobile device based system according to claim 15, wherein the at least one processing unit comprises a processing unit of the mobile device.

19. The mobile device based system according to claim 15, wherein the at least one processing unit comprises at least one of a processing unit of the mobile device and a processing unit of a computing device associated with the partner of the reward program.

20. The mobile device based system according to claim 15, wherein the at least one processing unit comprises at least one of a processing unit of the mobile device, a processing unit of a computing device associated with the partner of the reward program and a processing unit of a computing device associated with an issuer of the reward points, and wherein the issuer of the reward points is the employer.
